(19) United States
(12) Patent Application Publication
(10) Pub. No.: US 2025/0203651 A1
(43) Pub. Date: Jun. 19, 2025

(54) METHOD AND SYSTEM FOR CO-EXISTENCE OF C-V2X TRANSMISSIONS WITH OTHER TECHNOLOGIES

(71) Applicant: Autotalks Ltd., Kfar Netter (IL)

(72) Inventors: Shay Koren, Kfar Netter (IL); Eyal Nahum, Kfar Netter (IL); Onn Haran, Kfar Netter (IL); Nir Shapira, Kfar Netter (IL)

(21) Appl. No.: 18/953,103

(22) Filed: Nov. 20, 2024

Related U.S. Application Data
(60) Provisional application No. 63/561,845, filed on Mar. 6, 2024.
(60) Provisional application No. 63/611,175, filed on Dec. 17, 2023.

(51) Int. Cl. H04W 74/02; H04W 4/40

(52) U.S. Cl. CPC H04W 74/02; H04W 4/40

(57) ABSTRACT

Method and device for co-existence of cellular vehicle-to-everything (C-V2X) transmissions with other technologies, the method comprising: in a self-vehicle, in each C-V2X slot, measuring C-V2X energy and non-C-V2X energy of all subchannels, measuring pre-slot energy of all subchannels, if pre-slot energy exists in particular subchannels, using the measured pre-slot energy to overwrite stored historical measured energies of prior cycles in the particular subchannels, thereby obtaining an overwritten energy value, and if pre-slot energy is not measured in a particular subchannel scheduled for an upcoming transmission, perform the upcoming transmission as scheduled in the particular subchannel.

### CROSS REFERENCE TO RELATED APPLICATIONS

This application claims the benefit of priority from U.S. provisional patent applications No. 63/611,175 filed Dec. 17, 2023 and 63/561,845 filed Mar. 6, 2024, both of which are incorporated herein by reference in their entirety.

### FIELD

This disclosure relates in general to Semi-Persistent Scheduling (SPS) in cellular vehicle-to-everything (C-V2X) communications (or simply “C-V2X”), and in particular to SPS that shares a C-V2X channel with other non-SPS technologies such as Dedicated Short-Range Communications (DSRC).

### BACKGROUND

The C-V2X specification uses a “SPS approach” where a device selects transmission resources and continues using them in subsequent cycles until it reselects and selects new ones. C-V2X does not account for other technologies transmitting on the same channel, leading to non-polite channel access that prevents sharing. Non-SPS V2X technologies such as DSRC employ random channel access based on WiFi standards, transmitting only after confirming the channel is free of energy.

An example of failed coexistence is shown in FIG. 1A, where C-V2X and DSRC share a 20 MHz channel. C-V2X uses the entire 20 Mz channel, shared by multiple C-V2X devices, each using several subchannels, typically 2 MHz each, while DSRC uses the upper 10 MHz half of the channel. C-V2X follows fixed timing slots, allowing multiple devices to transmit on different subchannels in a single slot. For example, in a first slot, transmissions 121 and 122 come from two different devices. In a next slot 124, another C-V2X device is transmitted in the lower 10 MHz half of the channel. A DSRC device senses that the upper 10 MHz half channel is available, and transmits a transmission 111. Transmission 111 is shifted relative to slot 124 because C-V2X follows strict slots and DSRC can transmit at any time. Since C-V2X ignores other technologies, a planned C-V2X transmission 125 will collide with DSRC's ongoing transmission 126, causing both transmissions to fail.

It would be beneficial to prevent these collisions and to ensure successful coexistence, as illustrated below in FIG. 1B, in which C-V2X uses only the lower 10 MHz to prevent collisions.

### SUMMARY

Embodiments disclosed herein relate to a method and apparatus for co-existence for SPS with other non-SPS technologies. The following description applies to 3GPP (3rd Generation Partnership Project) C-V2X standards Release 14/15, commonly called LTE-V2X, and to Releases 16/17/18, commonly called 5G-V2X.

In exemplary embodiments, there is provided a method for co-existence of C-V2X transmissions with other technologies, comprising: in a self-vehicle, in each C-V2X slot: measuring C-V2X energy and non-C-V2X energy of all subchannels; measuring pre-slot energy of all subchannels, and, if pre-slot energy exists in particular subchannels, using the measured pre-slot energy to overwrite stored historical measured energies of prior cycles in the particular subchannels, thereby obtaining an overwritten energy value; and if pre-slot energy is not measured in a particular subchannel scheduled for an upcoming transmission, perform the upcoming transmission as scheduled in the particular subchannel. In some examples, the non-C-V2X energy is Dedicated Short-Range Communications (DSRC) energy.

In some examples, a method further comprises, if pre-slot energy is measured in a subchannel scheduled for an upcoming transmission, cancelling transmission in all suchannels selected for transmission.

In some examples, a method further comprises forcing resource reselection. In some examples, the forcing resource reselection includes reselecting resources using the overwritten energy value.

In some examples, a method further comprises, if pre-slot energy is measured in a subchannel not scheduled for an upcoming transmission, transmit as scheduled.

In some examples, the overwriting of the stored historical measured energies of prior cycles in the particular subchannels is in the form Energy (cycle-9:cycle, current slot-1:current slot)=pre-slot energy.

In exemplary embodiments, there is provided a C-V2X access layer device, comprising: an enhanced energy measurement unit configured to measure pre-slot energy in all subchannels before each slot starts and for outputting measured pre-slot energy, to use the measured pre-slot energy to overwrite slot subchannel energy measurements from the last 1 second to obtain an overwritten energy value and to force the measured pre-slot energy for the relevant slots and subchannels during current and past cycles; a pre-slot activation unit configured to control a timing of the pre-slot energy measurement; an enhanced resource energy measurement unit configured to measure in-slot non-C-V2X energy in addition to C-V2X energy; and a legacy resource reservation module configured to determine the transmission slot using the measured pre-slot energy values, in-slot energy measurements values and the overwritten energy value.

In some examples, the legacy resource reservation module is configured to force resource reselection. In some examples, the resource reselection includes resource reselection using the overwritten energy value.

In some examples, the overwritten energy value is given by Energy (cycle-9:cycle, current slot-1:current slot)=pre-slot energy.

### BRIEF DESCRIPTION OF THE DRAWINGS

Non-limiting embodiments of the presently disclosed subject matter are described below with reference to figures attached hereto that are listed following this paragraph. Identical structures, elements or parts that appear in more than one figure may be labeled with the same numeral in the figures in which they appear. The drawings and descriptions are meant to illuminate and clarify examples disclosed herein, and should not be considered limiting in any way. In the drawings:

FIG. 1A illustrates an example of a failed co-existence using a known method;

FIG. 1B illustrates an example of a successful co-existence according to an exemplary embodiment disclosed herein;

FIG. 2A illustrates a block diagram of a known standard SPS system;

FIG. 2B illustrates a block diagram of a SPS coexistence system according to an exemplary embodiment disclosed herein;

FIG. 3 illustrates a flow chart of SPS coexistence operation according to an exemplary embodiment disclosed herein;

FIG. 4 illustrates a flow chart of pre-slot actions;

FIG. 5 illustrates a flow chart of actions before transmission;

FIG. 6 illustrates an example of transmissions applying co-existence between SPS and non-SPS technologies according to an exemplary embodiment disclosed herein.

### DETAILED DESCRIPTION

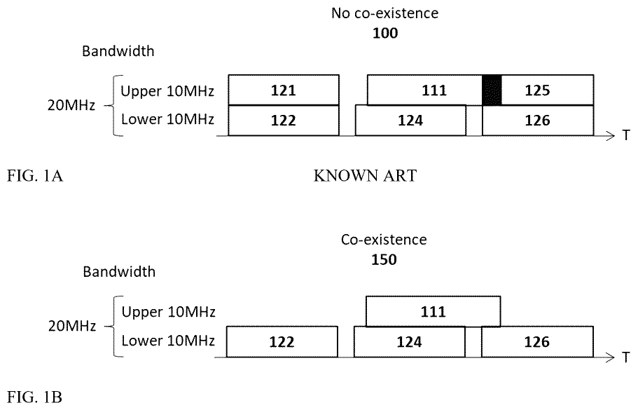

FIG. 1B illustrates an example of a successful co-existence according to an exemplary embodiment disclosed herein. The transmissions are similar to FIG. 1A, except that transmission 125 is canceled so as not to collide with DSRC transmission 111, and that transmission 121 is canceled because the time of DSRC transmission 111 fluctuates. Therefore, sufficient buffer needs to be allocated before and after the DSRC transmission to avoid interference with other technologies.

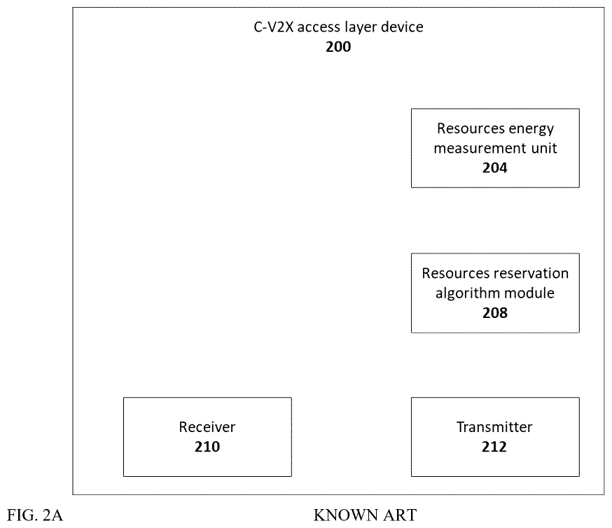

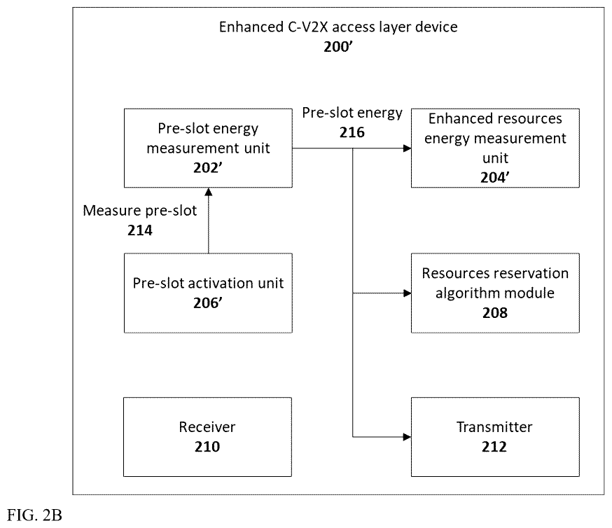

The failed coexistence described above occurs when one uses a known standard SPS system, illustrated in FIG. 2A. The figure shows only the relevant (to this disclosure) part of the system. The standard SPS system comprises a C-V2X access layer device 200 that includes a resource energy measurement unit 204, a legacy resources reservation module 208, a receiver (RX) 210 and transmitter (TX) 212. Resource energy measurement unit 204 measures only the energy of received C-V2X messages during expected slots (i.e. “in-slot” energy measurement) in all subchannels. Legacy resources reservation module 208 uses the measured C-V2X energy to determine the slot and sub-channels in which a self-device can transmit while minimizing interference with other C-V2X devices in proximity. Receiver 210 operates during all slots, except the slot scheduled for transmission. Transmitter 212 is activated at the scheduled slot.

In contrast, and according to exemplary embodiments disclosed herein, a part of a SPS system that supports SPS co-existence as indicated in FIG. 1B and below is illustrated by a block diagram in FIG. 2B. FIG. 2B shows an enhanced C-V2X access layer device (or simply “device”) 200′ that comprises an enhanced energy measurement unit 202′, a resource energy measurement unit 204′, a pre-slot activation unit 206′, legacy resources reservation module 208, RX 210 and TX 212. As used herein with relation to device 200′ device components, “enhanced” indicates new and/or changed functionality vs. the functionalities of respective parallel known legacy device components.

Enhanced energy measurement unit 202′ is configured to measure pre-slot energy in all subchannels before each slot starts, to output a measured pre-slot energy 216.

Enhanced resource energy measurement unit 204′, in contrast with unit 204 of C-V2X access layer device 200, is configured to measure also in-slot non-C-V2X received energy (i.e. energy that arrived from a transmitter which does not use C-V2X technology, specifically DSRC). Note that in this description, all “pre-slot energy” is essentially non-C-V2X energy. The measured non-C-V2X energy is not only considered in a current measurement but is also used to overwrite historical energy measurements for the same slot. In C-V2X, a history of 1 second (“last 1 second”) of all slot subchannel measurements is kept. Therefore, any measured non-C-V2X energy impacts also the preceding 9 measurements. In other words, enhanced resources energy measurement unit 204′ is also configured to use the measured pre-slot non-C-V2X energy to overwrite slot subchannel energy measurements from the last second (thereby obtaining an “overwritten energy value”, also referred to as “new measurement”) and to force the pre-slot measured energy for the relevant slots and subchannels during current and past cycles. The measurement after the update with the pre-slot energy is a “new” measurement.

Pre-slot activation unit 206′ is configured to control timing of the pre-slot energy measurement and to provide a pre-slot measure 214, i.e. a command that commands to perform an energy measurement outside a slot boundary, unlike in a legacy system, where the measurement is always performed withing a slot boundary.

Legacy resource reservation module 208 acts upon the measurements (i.e. runs the selection algorithm using the received C-V2X energy measurement), and determines the slot and sub-channels in which the self-device can transmit while minimizing interference with other C-V2X and non-C-V2X devices in proximity. That is, module 208 determines the transmission slot using the measured pre-slot energy values, in-slot energy measurements values and the overwritten energy value. In other words, legacy resource reservation module 208 uses the new measurement (i.e. the overwritten energy value) to force reselection of a new transmission resource slot if pre-slot energy is measured when the device is scheduled to transmit in the current slot and subchannel through transmitter 210. Transmitter 210 also applies the pre-slot energy measurement to skip transmission in all subchannels if energy is present in the scheduled subchannels.

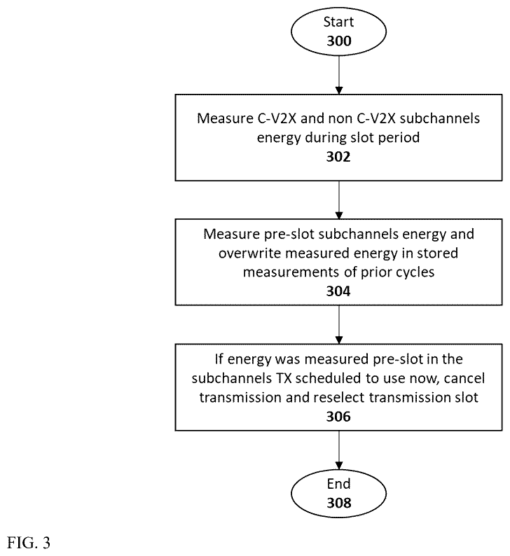

FIG. 3 illustrates a flow chart of SPS coexistence operation according to some exemplary embodiments, performed in the C-V2X access layer of the self-vehicle using an enhanced C-V2X access layer device like device 200′. This process can be implemented in combination of hardware (HW) blocks (units) and controller software (SW). The operation begins in step 300 with every C-V2X slot (1 msec period for LTE-V2X and 0.5 msec period for 5G-V2X). Next, in step 302, C-V2X and non-C-V2X subchannels energy is measured during the slot period by enhanced resources energy measurement unit 204′. Next, in step 304, pre-slot subchannels energy is measured in pre-slot energy measurement unit 202′. The pre-slot energy is measured in all subchannels, where some may have pre-slot energy while others may not. The measured pre-slot energy, if existing (i.e. not measured noise) overwrites historical measured energies of prior cycles stored in unit 204′. That is, the measurements of the same subchannels and slots during the last second receive the measured pre-slot value. Next, in step 306, if energy was measured pre-slot in the subchannels scheduled for transmission, cancel transmission and reselect transmission slot. The condition for the cancellation in a subchannel is if transmission is scheduled in the upcoming slot, and if the transmission subchannel is identical to a subchannel in which pre-slot energy is measured. That is, if TX 212 is expected to transmit, and pre-slot energy is measured but in different subchannels than scheduled, then transmission can be performed as scheduled. Next, the operation ends in step 308.

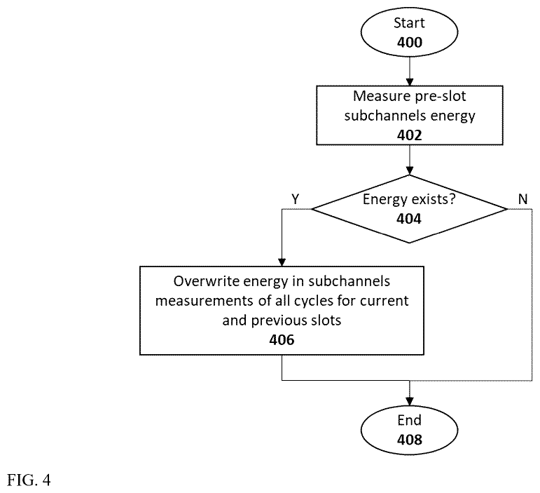

FIG. 4 provides in a flow chart details of step 304 of FIG. 3. The operation begins in step 400 when step 304 is called. Next, in step 402, pre-slot energy measurement unit 202′ measures pre-slot energy (before the slot begins) in all subchannels, starting X μsec (for example 32 μsec) before the slot begins and for a duration of Y μsec (for example 16 μsec). Next, step 404 checks if energy is measured (exists). A criterion for energy existence may include a threshold. The threshold above which energy existence is declared may be for example −85 dBm, as with the common WiFi Clear Channel Assessment (CCA) threshold. If no pre-slot energy is measured, the operation ends (overwrite is skipped) at step 408. Otherwise, the operation continues to step 406, in which the non-C-V2X energy measured by enhanced resources energy measurement unit 204′ is overwritten in respective subchannels with measured pre-slot energy current and past cycles for current and previous slots. This ensures that averaging across all cycles will yield the measured non-C-V2X energy. The representation of the overwritten value is:
Energy (cycle-9:cycle, current slot-1:current slot)=pre-slot energy,
   considering that energy is measured for 10 allocation cycles. Next, the operation ends (overwrite is completed) at step 408.

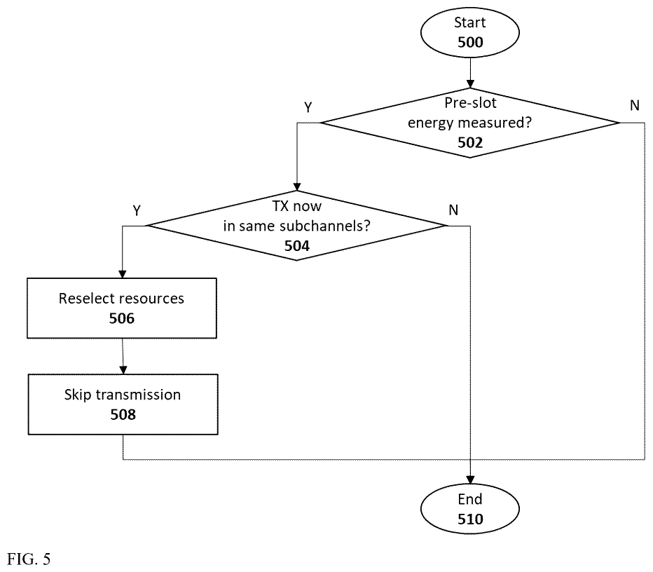

FIG. 5 provides in a flow chart details of step 306. The operation begins in step 500 when step 306 is called. Next, step 502 is identical to the check of step 404, checking if pre-slot energy was measured in a particular subchannel scheduled for an upcoming transmission. If no, the operation ends (transmission is cancelled) in step 510. If yes, the operation continues from check 504. If enhanced C-V2X device 200′ is not expected to transmit in the current slot in the subchannel where energy was measured, then operation ends at step 510. Otherwise, operation continues from step 506, in which resource reselection is forced (i.e. performed currently even if according to the legacy algorithm it is expected to be performed only in the future) in resource reservation module 208. The “forcing” is performed using a command to reselect resources. Next, the operation continues from step 508, in which transmitter 210 skips the upcoming transmission. Next, the operation ends at step 510.

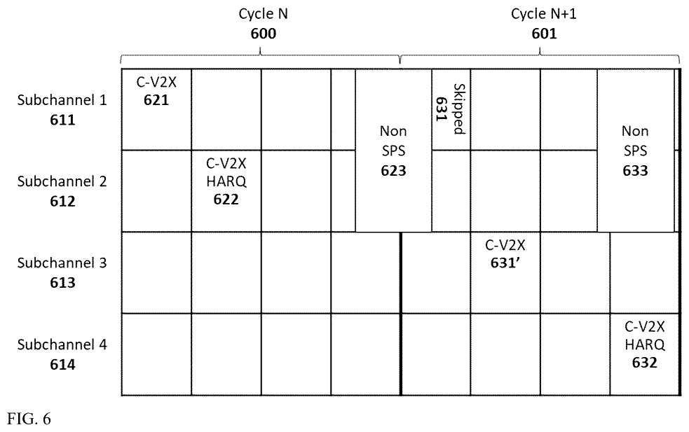

FIG. 6 illustrates an example of transmissions applying co-existence between SPS and non-SPS technologies, according to a SPS coexistence operation described above. The example depicts 2 cycles, N 600 and N+1 601. For simplicity, each cycle is shown with 4 slots (or simply “slots” just slots) instead of the typical 100 or 200 slots, and the channel is divided into 4 subchannels 611, 612, 613, and 614 rather than the usual 10 or 20 subchannels. The transmissions of two vehicles are shown: one using C-V2X technology, transmitting twice per cycle, and the other using non-SPS technology, specifically WiFi-based DSRC, transmitting once per cycle.

In the first cycle 600, the C-V2X vehicle transmits the first copy at 621 and a Hybrid automatic repeat request (HARQ) copy at slot 622. The DSRC vehicle transmits at slot 623, unsynchronized with C-V2X slots and cycle boundaries. Before the first slot of cycle N+1 601, the C-V2X device detects the DSRC transmission and overwrites the measured pre-slot energy in the respective subchannels of current and previous slots, which are the first and last slots of a cycle. Since the C-V2X device? Yes is scheduled to transmit, the next transmission 631 is skipped, and resource reselection is forced. As a result, upcoming C-V2X transmission 631′ and HARQ 632 and the DSRC transmission 633 share the channel without interference.

It should be understood that where the claims or specification refer to “a” or “an” element, such reference is not to be construed as there being only one of that element.

All patents and patent applications mentioned in this specification are herein incorporated in their entirety by reference into the specification, to the same extent as if each individual patent or patent application was specifically and individually indicated to be incorporated herein by reference. In addition, citation or identification of any reference in this application shall not be construed as an admission that such reference is available as prior art to the present disclosure.

While this disclosure has been described in terms of certain examples and generally associated methods, alterations and permutations of the examples and methods will be apparent to those skilled in the art. The disclosure is to be understood as not limited by the specific examples described herein, but only by the scope of the appended claims.

What is claimed is:

1. A method for co-existence of cellular vehicle-to-everything (C-V2X) transmissions with other technologies, comprising: in a self-vehicle, in each C-V2X slot:
measuring C-V2X energy and non-C-V2X energy of all subchannels;
measuring pre-slot energy of all subchannels, and, if pre-slot energy exists in particular subchannels, using the measured pre-slot energy to overwrite stored historical measured energies of prior cycles in the particular subchannels, thereby obtaining an overwritten energy value; and
if pre-slot energy is not measured in a particular subchannel scheduled for an upcoming transmission, perform the upcoming transmission as scheduled in the particular subchannel.

2. The method of claim 1, further comprising, if pre-slot energy is measured in a subchannel scheduled for an upcoming transmission, cancelling transmission in all suchannels selected for transmission.

3. The method of claim 2, further comprising forcing resource reselection.

4. The method of claim 1, further comprising, if pre-slot energy is measured in a subchannel not scheduled for an upcoming transmission, transmit as scheduled.

5. The method of claim 1, wherein the non-C-V2X energy is Dedicated Short-Range Communications (DSRC) energy.

6. The method of claim 1, wherein the overwriting of the stored historical measured energies of prior cycles in the particular subchannels is in the form Energy (cycle-9:cycle, current slot-1:current slot)=pre-slot energy.

7. The method of claim 3, wherein the forcing resource reselection includes reselecting resources using the overwritten energy value.

8. A cellular vehicle-to-everything (C-V2X) access layer device, comprising:
an enhanced energy measurement unit configured to measure pre-slot energy in all subchannels before each slot starts and for outputting measured pre-slot energy, to use the measured pre-slot energy to overwrite slot subchannel energy measurements from the last 1 second to obtain an overwritten energy value and to force the measured pre-slot energy for the relevant slots and subchannels during current and past cycles;
a pre-slot activation unit configured to control a timing of the pre-slot energy measurement;
an enhanced resource energy measurement unit configured to measure in-slot non-C-V2X energy in addition to C-V2X energy; and
a legacy resource reservation module configured to determine the transmission slot using the measured pre-slot energy values, in-slot energy measurements values and the overwritten energy value.

9. The C-V2X access layer device of claim 8, wherein the legacy resource reservation module is configured to force resource reselection.

10. The C-V2X access layer device of claim 9, wherein resource reselection includes resource reselection using the overwritten energy value.

11. The C-V2X access layer device of claim 8, wherein the overwritten energy value is given by Energy (cycle-9:cycle, current slot-1:current slot)=pre-slot energy.

12. The C-V2X access layer device of claim 8, wherein the non-C-V2X energy is Dedicated Short-Range Communications (DSRC) energy.

13. The C-V2X access layer device of claim 8, included in a vehicle.
